(19) United States
(12) Patent Application Publication
(10) Pub. No.: US 2010/0327579 A1
(43) Pub. Date: Dec. 30, 2010

(54) FLUID FITTING

(75) Inventor: Noah Montena, Syracuse, NY (US)

Correspondence Address: Marjama Muldoon/PPC, 250 South Clinton Street, Suite 300, Syracuse, NY, 13202, US

(73) Assignee: John Mezzalingua Associates, Inc., East Syracuse, NY (US)

(21) Appl. No.: 12/491,461

(22) Filed: Jun. 25, 2009

(51) Int. Cl. F16L 13/14

(52) U.S. Cl. 285/382

(57) ABSTRACT

A fitting for securing a first fluid conduit to a second fluid conduit includes a coupling body and a die ring. The coupling body includes a first end and a second end defining an enclosed passage along a longitudinal axis therethrough. The first end of the coupling body includes a deformable compression sleeve having an outer diameter and an inner diameter defining a thickness. The die ring is disposed in surrounding relation to the compression sleeve, and includes an inner surface and engagement surface, wherein the engagement surface includes a diameter that is less than the outer diameter of the compression sleeve. When the first fluid conduit is inserted into the coupling body, the die ring engagement surface is adapted to compress the compression sleeve radially inward when the die ring is urged in an axial direction towards a second end of the coupling body. At least a portion of the compression sleeve flows between the inner surface of the die ring and an outer surface of the first fluid conduit. In one embodiment, the first fluid conduit is a hydraulic hose. In another embodiment, the first fluid conduit is cross-linked polyethylene tubing.

### FIELD OF THE INVENTION

This invention relates generally to the field of fluid fittings, and more particularly to an apparatus and method for improved sealing in a fluid coupling.

### BACKGROUND OF THE INVENTION

Conventional fluid connections such as hydraulic hose fittings typically include a section of flexible hose, a main coupling body through which the fluid passes, and a coupling element. The main coupling body includes on one end a hollow serrated nipple over which the flexible hose is placed, and a crimping element to retain the hose on the nipple. The crimping element may be a separate crimp ring, or a crimp socket integral with the fitting body. On the other end of the main body is typically a coupling element such as a swivel nut or male thread.

In one procedure to create a fluid connection, the flexible hose is inserted over the barbed nipple. The hose and main body are placed in a hydraulic press having a 6-point die to deform the crimping element. The crimping element is circumferentially crushed by the press, causing the hose to be permanently retained on the nipple. The coupling element on the other end of the fitting may then be attached to a port, for example.

One drawback noted with crimped hydraulic fittings is that the crimping equipment is large, heavy, and difficult to transport. A crimping apparatus typically includes a hydraulic press and requires either compressed air or an electrical power source to operate. Thus, the equipment remains stationary and is not easily adapted to function at local work sites. For this reason, a user in need of a hydraulic hose typically places an order with a hose supplier, specifying the hose type and the particular coupling element desired, and waits for delivery of the hose. This process can span several days and can result in significant downtime, especially in emergency situations. Some users pre-order various hose configurations to have them on-hand, but this creates waste and excess inventory.

Another drawback to crimped hydraulic hoses is that the crimping is non-uniform around the circumference of the hose. The hydraulic press forces a 6-point die or a 12-point die over the crimp ring or crimp socket to crush it in place, meaning that the crimping force is applied at 6 or 12 discrete points around the circumference. Two potential problems develop from this approach. First, the crimping force may be intentionally higher than needed at the points of contact in order to assure the areas of lowest force (e.g., in between the points of contact) are sufficient to keep the hose secured in place under all operating conditions. The areas of higher force may cause locally overstressed areas. The overstressed areas are susceptible to cracking, or may shorten the life of the coupling. Second, in order to prevent overstressing the crimping element at the point of contact, a more moderate force may be applied during the crimping process. This may potentially leave areas around the circumference that do not crimp properly, leading to leaks or failure of the joint. Thus, the application of non-uniform force to the crimping element is a drawback.

In other fluid connection applications, such as flexible cross-linked polyethylene (PEX) tubing utilized in household plumbing, flexible tubing is mated to a distribution manifold. In one installation, the tubing is attached to the manifold by first sliding a crimp ring over the tubing and then mating the tubing over a ribbed fitting on the distribution panel. The crimp ring is then positioned ⅛ to ¼ of an inch from the end of the tubing, coinciding with the ribs on the fitting. A hand-held crimping tool then crushes the crimp ring over the fitting to secure the tubing. One drawback to this arrangement is that improper use of the hand tool may result in an irregular crimping force, which may result in leaks or shortened service life.

In still other fluid connection applications, such as copper piping used in household plumbing, the pipe is soldered to establish a fluid connection. Soldering is labor-intensive and requires expertise. Soldering also presents a fire hazard if not carried out properly.

Rigid piping such as polyvinylchloride (PVC) can also be difficult to assemble. PVC plumbing requires special glues, expertise to install, and is typically quite messy.

Soldering copper pipe and joining PVC fittings may also leave byproducts such as solder flux or residual glue inside of the pipe or tubing. The contamination from the joining process may be harmful or detrimental to the fluids being flowed. The pipe or tube may therefore require flushing before it can be used in service.

### SUMMARY OF THE INVENTION

In view of the background, it is therefore an object of the present invention to provide a fluid coupling that alleviates many of the problems encountered in the prior art. Briefly stated, a fitting for securing a first fluid conduit to a second fluid conduit includes a coupling body comprising a first end and a second end defining an enclosed passage along a longitudinal axis. The first end of the coupling body includes a deformable compression sleeve. The fitting further includes a die ring disposed in surrounding relation to the compression sleeve. At least a portion of a central bore within the die ring has an engagement surface. The engagement surface includes a diameter that is less than the outer diameter of the compression sleeve. The engagement surface is adapted to compress the compression sleeve radially inward when the die ring is urged in an axial direction towards the second end of the coupling body such that a length of the compression sleeve deforms between the inner surface of the die ring and an outer surface of the first fluid conduit.

According to an embodiment of the invention, a fluid fitting is provided wherein at least one of the die ring and the compression sleeve includes a taper angle relative to the axis.

According to another embodiment of the invention, a fluid fitting is provided that further includes a cylindrical cavity, and a tubular-shaped nipple is disposed in the cavity to support the first fluid fitting. The nipple defines the enclosed passage for passing a fluid from the first fluid conduit to the second fluid conduit.

According to another embodiment of the invention, a method for securing a fluid conduit to a fluid fitting is provided. The method includes a step of providing a coupling body, wherein the coupling body has a first end and a second end defining an enclosed passage along a longitudinal axis, and a cavity adapted to accept the fluid conduit. The first end of the coupling body includes a deformable compression sleeve having an outer diameter and an inner diameter defining a thickness. The method further includes a step of providing a die ring, wherein the die ring has an engagement surface including a diameter that is less than the outer diameter of the compression sleeve. The method further includes a step of inserting the fluid conduit into the cavity of the coupling body, applying a force to the die ring in a direction towards the second end of the coupling body, sliding the die ring in a direction along the axis to engage the compression sleeve, and deforming the compression sleeve radially inwards against the first fluid conduit to provide a continuous seal around the periphery of the conduit.

### BRIEF DESCRIPTION OF THE DRAWINGS

The novel features that are characteristic of the preferred embodiment of the invention are set forth with particularity in the claims. The invention itself may be best be understood, with respect to its organization and method of operation, with reference to the following description taken in connection with the accompanying drawings in which:

FIG. 1 shows a perspective sectional view of a fluid fitting according to an embodiment of the invention;

FIG. 2 shows a sectional view of the coupling body shown in FIG. 1;

FIG. 3 shows a sectional view of the die ring shown in FIG. 1;

FIG. 4A shows a sectional view of one embodiment of the die ring and compression sleeve shown in FIG. 1;

FIG. 4B shows a sectional view of a second embodiment of the die ring and compression sleeve shown in FIG. 1;

FIG. 4C shows a sectional view of a third embodiment of the die ring and compression sleeve shown in FIG. 1;

FIG. 4D shows a sectional view of a fourth embodiment of the die ring and compression sleeve shown in FIG. 1;

FIG. 5A shows a sectional view of one embodiment of the coupling body assembled to a fluid coupling;

FIG. 5B shows a sectional view of another example of the assembly of FIG. 5A;

FIG. 6 shows a perspective sectional view of a fluid fitting according to a second embodiment of the invention;

FIG. 7 shows a sectional view of the coupling body shown in FIG. 6;

FIG. 8 shows a sectional view of the nipple shown in FIG. 6;

FIG. 9 shows a perspective sectional view of a fluid fitting according to a third embodiment of the invention;

FIG. 10 shows a sectional view of the coupling element shown in FIG. 9;

FIG. 11 shows a perspective sectional view of a fluid fitting according to a fourth embodiment of the invention.

### DETAILED DESCRIPTION OF THE PREFERRED EMBODIMENT

Coupling a flexible fluid conduit such as a hydraulic hose to a rigid fluid conduit such a flange fitting typically involves sliding the flexible conduit over a ribbed or barbed sleeve, then applying a compressive force to a crimp ring positioned around the sleeve. As the ring is crushed, it squeezes the flexible conduit against the sleeve. Serrations, ribs, or barbs on the sleeve typically retard movement of the flexible conduit once it is held in place. One noted problem with such an arrangement is that the compressive crimping stress is non-uniform, which may lead to a faulty seal or overstress of the crimping ring material.

The inventor of the present invention has created an arrangement and method that allows for a uniform seal around flexible conduit, thereby alleviating the problems and conditions noted in the prior art. The apparatus and method disclosed herein provides a superior coupling joint over the prior art crimp ring arrangements. The invention as disclosed is not limited to flexible conduit. The inventor has determined the invention may also be adapted to provide a superior sealing apparatus and method for rigid fluid conduit connections, such as copper and PVC plumbing.

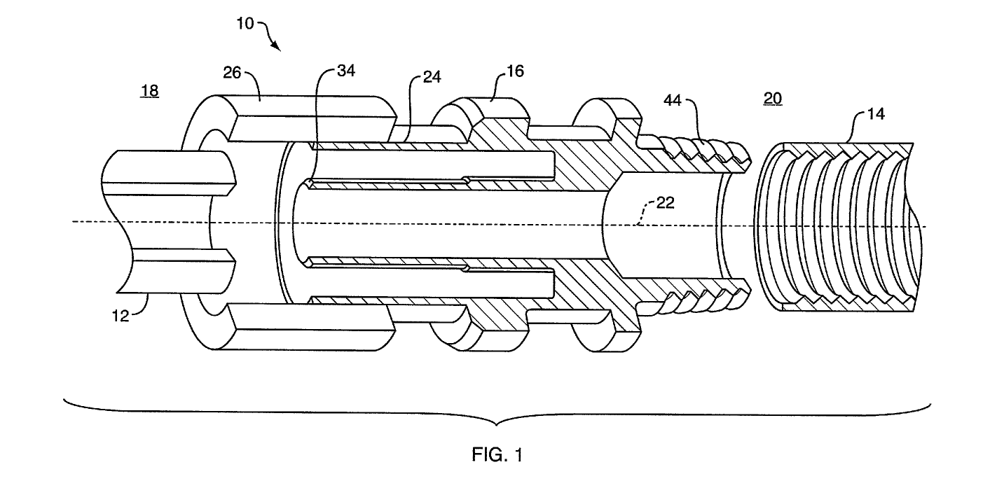

Referring to FIG. 1 of the drawings, a fluid fitting 10 is shown for use in joining a first fluid conduit 12 to a second fluid conduit 14. In the disclosed example, the first fluid conduit 12 is a flexible hydraulic hose, and the second fluid conduit 14 is a manifold block. The fluid fitting 10 includes a coupling body 16 having a first end 18 and a second end 20 defining a longitudinal axis 22. The first end 18 of the coupling body 16 includes a thin-walled cylindrical compression sleeve 24. A die ring 26 is adapted to slide on the compression sleeve 24 along the axis 22 in a direction toward the second end 14 of the coupling body 16. As will be discussed in detail below, the die ring 26 and the compression sleeve 24 are sized such that urging the die ring toward the second end 14 of the coupling body 16 causes the compression sleeve to deform radially inwards to effect a uniform seal around the first fluid conduit 12.

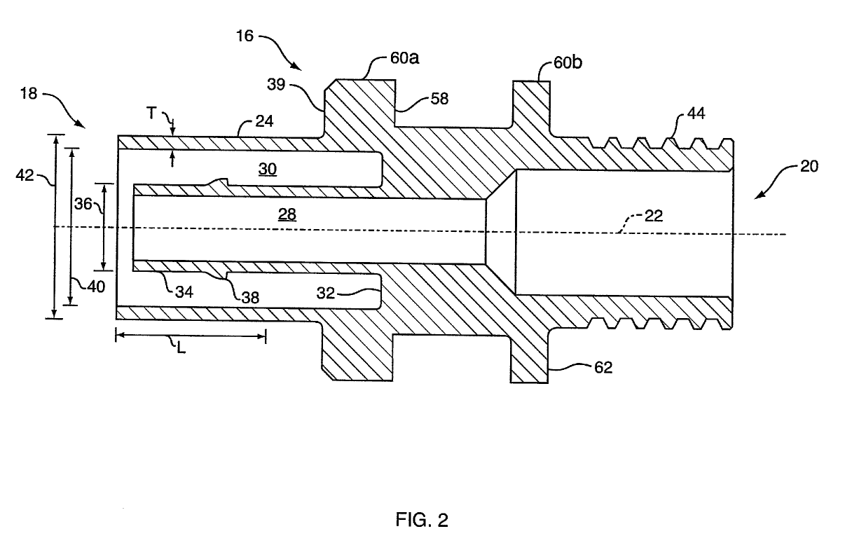

Referring to FIG. 2, the coupling body 16 is shown in cross sectional view. The coupling body 16 includes an internal enclosed passageway 28 for allowing a fluid to flow from the first fluid conduit 12 to the second fluid conduit 14. The coupling body 16 defines a cylindrical cavity 30 to accept the first fluid conduit 12 and further defines a surface 32 that provides a positive stop when engaging the first fluid conduit 12 into the cavity. The surface 32 also assures the first fluid conduit 12 is inserted to a proper depth. In some embodiments, the first end 18 of the coupling body 16 includes a tubular-shaped nipple 34 to provide support for the first fluid conduit 12. The nipple 34 defines an outer diametrical surface 36 to which the inner diameter of the first fluid conduit 12 slides over. In some examples, the nipple 34 may include at least one barb or protrusion 38 to prevent the first fluid conduit 12 from backing out of the cavity 30. The coupling body 16 may include a forward surface 39 to be used as a positive stop for the die ring 26, as will be discussed in detail below.

The compression sleeve 24 may be formed from a thin-walled, ductile material such as brass. An inner diameter 40 of the compression sleeve 24 is sized, in an un-deformed state, to be larger than the outer diameter of the first fluid conduit 12 to prevent interference during assembly. Together, the inner diameter 40 and an outer diametrical surface 42 of the compression sleeve 24 define a thickness T over a length L. In order to assure adequate deformation of the sleeve 24 during the compression process, the length L is greater than the thickness T. In one example, the length L is about an order of magnitude greater than the thickness T. In a preferred embodiment, the length L has a length along the axis at least five times greater than the thickness. In this manner, a long, thin, ductile sleeve is formed that is easily deformed during assembly.

Although in one example the compression sleeve 24 is made of brass, other ductile materials that are malleable would work well in the context of the invention. For example, the compression sleeve 24 may be made of plastic or polycarbonate material. In the illustrated example, the compression sleeve 24 is integral to the coupling body 16. However, the inventor contemplates that a distinct and separate sleeve 24 may be utilized without departing from the scope of the present invention.

The second end 20 of the coupling body 16 defines a coupling element 44. In the illustrated example, a male thread is shown, as may be used when the second fluid conduit 14 is a manifold block. A wide variety of coupling elements 44 could be adapted for use with the coupling body 16. For example, the coupling element 44 may comprise a female flare fitting (e.g., JIC swivel nut, SAE J514, or MIL-F-18866), a fixed female nut, a male thread as shown, or a swivel head male connection, just to name a few.

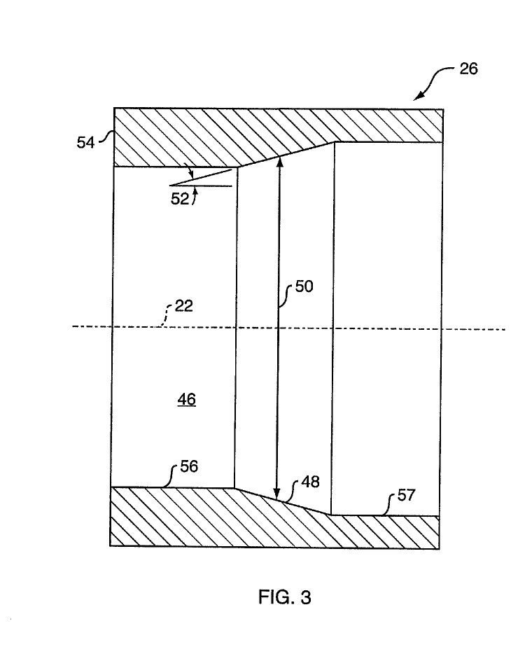

Referring to FIG. 3 of the drawings, the die ring 26 is shown in cross-sectional view. The die ring 26 may be generally cylindrical in shape and define an inner bore 46. The inner bore 46 includes a minimum diameter 56, an engagement surface 48 with a diameter 50 that is less than the outer diametrical surface 42 of the compression sleeve 24 (FIG. 2), and optionally, an pilot diameter 57. In some embodiments, the engagement surface 48 is a frustoconical surface at a taper angle 52 relative to the axis 22. The engagement surface 48 may also be cam-shaped. The pilot diameter 57 may be sized to provide a slight interference fit with the outer diameter of the compression sleeve 24. The die ring 26 further includes a first tooling surface 54 for engaging an assembly tool (not shown). In the disclosed embodiment, the tooling surface 54 is normal, or perpendicular, to the axis 22. A minimum diameter 56 of the inner bore 46 of the die ring 26 is preferably sized greater than the outside diameter of the first fluid conduit 12 to facilitate assembly.

The die ring 26 may be stiffer than the compression sleeve 24 to limit the deflection of the die ring relative to the sleeve. One method of achieving the stiffness is to fabricate the die ring 26 from a material that has a higher modulus of elasticity than the material of the compression sleeve 24. In this manner, for a given radial force, the compression sleeve 24 will deform more than the die ring 26. Thus, the die ring 26 may be designed relatively thin, but will deflect less than the compression sleeve 24. In one example, the compression sleeve 24 is made of nylon or plastic, and the die ring 26 is made of brass. In another example, the compression sleeve 24 is made of brass, and the die ring 26 is made of carbon steel.

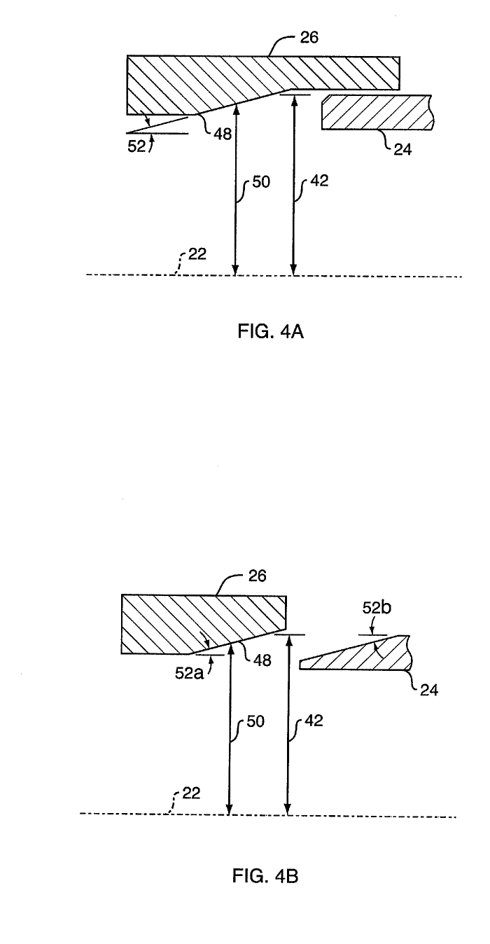

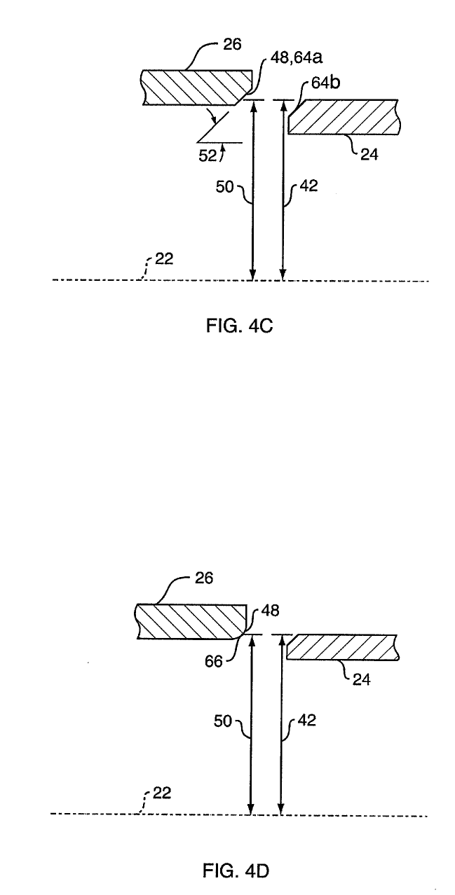

Referring to FIGS. 4A-4D, various embodiments of the engagement surface 48 and taper angle 52 are shown. FIG. 4A depicts one embodiment wherein the engagement surface 48 includes a taper angle 52 that is approximately 15 degrees. FIG. 4B illustrates a second embodiment wherein the engagement surface 48 includes a taper angle 52a that is approximately 15 degrees, and the compression sleeve 24 has a complimentary taper angle 52b that is also approximately 15 degrees. In this configuration, the engagement surface 48 is essentially parallel with the mating surface on the compression sleeve 24, which maximizes the surface area over which the radial compressive force is applied. In a third embodiment illustrated in FIG. 4C, the engagement surface 48 comprises a standard chamfer 64a having a taper angle 52 in the range of 30 to 45 degrees. The opposing mating surface on the compression sleeve 24 is also a chamfer 64b. This particular arrangement may be adequate when the compression sleeve 24 is made of plastic. In a fourth embodiment shown in FIG. 4D, the engagement surface 48 comprises a radius 66. This arrangement may also work well when the compression sleeve 24 is made of a soft, ductile material such as plastic.

The degree of taper angle 52 may vary according to the particular application. In one disclosed example, wherein the first fluid conduit 12 is a hydraulic hose, the compression sleeve 24 is brass, and the die ring 26 is steel, the taper angle 52 may be shallow, for example between 1 degree and 20 degrees. The taper angle 52 permits the axial force imparted by the assembly tool to be transposed to a radial compressive force along the engagement surface 48. A shallow taper angle 52 will result in the radial force being spread over a greater portion of the engagement surface 48 so the die ring 26 and compression sleeve 24 are less likely to bind up. In another example, wherein the compression sleeve 24 is plastic, the taper angle 52 may be as much as 45 degrees with no assembly problems. In some examples, a lubricant such as powdered graphite may be applied over the engagement surface 48 on the die ring 26 or the outer diametrical surface 42 of the compression sleeve 24.

Referring now to FIGS. 1-3, the coupling body 16 further includes a second tooling surface 58 for engaging the assembly tool. In the disclosed embodiment, the tooling surface 58 is normal to the axis 22. However, other tooling surfaces are contemplated according to the particular arrangement of the assembly tool. For example, outer diameters 60a and/or 60b may have wrenching flats to assist in assembling the first and second fluid conduits 12, 14. The operation of one example assembly tool will be explained in detail below.

To assemble the first fluid conduit 12 to the second fluid conduit 14 using the inventive fluid fitting 10 disclosed herein, the second end 20 of the coupling body 16 may be installed first. In one example, the second fluid conduit 14 is a manifold block. The male threads on the coupling body 16 may be threaded into the female threads on the manifold block using wrenching flats 60a or 60b. Seal surface 62 may be adapted to accept a rubber o-ring seal.

The fluid fitting 10 may be conveniently packaged with the die ring 26 pushed in a hand-tight fit over the compression sleeve 24. In this case, the first fluid conduit 12 may be inserted through a die ring inner bore 46 and into the cylindrical cavity 30 of the coupling body 16 until the conduit 12 abuts the surface 32. The assembly tool (not shown) may be a split tool and include jaws that grasp the first and second tooling surfaces 54 and 58, respectively, and squeeze them towards each other. As the tool imparts an axial force (in a direction parallel to axis 22) to the surfaces 54 and 58, the die ring 26 is urged axially along axis 22 towards the second end 20 of the coupling body 16 until diameter 50 on the engagement surface 48 engages the outer diametrical surface 42 of the compression sleeve 24. At this point, because the die ring 26 has a higher elastic modulus than the compression sleeve 24, further urging and axial movement of the die ring causes the engagement surface 48 to slide along the outer diametrical surface 42 and compress the compression sleeve 24 radially inward. The compression sleeve 24, being more ductile than the die ring 26, undergoes uniform radially inward deformation as the die ring 26 is further urged along the axis 22. The uniform radial deformation pushes the compression sleeve 24 against the first fluid conduit 12 to allow for a uniformly tight seal around the outer diameter of the first fluid conduit 12, and physically retains the first fluid conduit 12 from movement. The die ring 26 may be urged to its full travel, which in one example is the forward surface 39 of the coupling body 16.

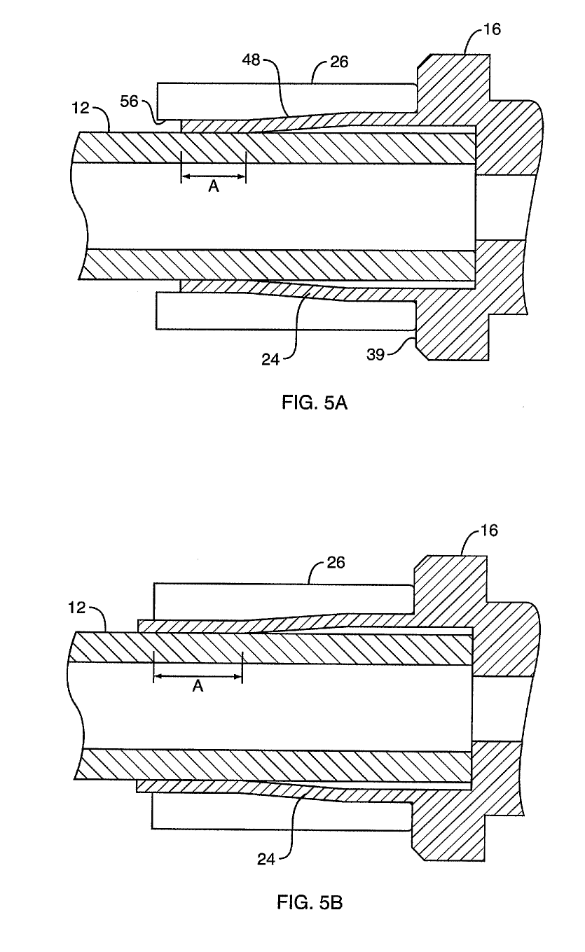

Referring to FIGS. 5A and 5B of the drawings, the first fluid conduit 12 is shown assembled to the coupling body 16. The compression sleeve 24, being more ductile than the die ring 26, is deformed by the engagement surface 48 of the die ring 26 such that at least a portion of the compression sleeve 24 deforms between the die ring 26 and the first fluid conduit 12. This portion, designated as area A, is generally sandwiched between the inner surface 56 of the die ring 26 and the outer surface of the first fluid conduit 12, away from the engagement surface 48. In some examples, the compression sleeve 24 may protrude out from the die ring 26, as shown in FIG. 4B. In one example, the compression sleeve material undergoes plastic deformation, such that the sleeve 24 plastically flows between the die ring 26 and first fluid conduit 12. In another example, the compression sleeve material undergoes elastic deformation such that the sleeve 24 deforms to fill the space between the die ring 26 and the first fluid conduit, but retains its original shape when disassembled. Because the compressive force is spread out over a relatively large surface A, rather than at a discrete point or points, the compressive stress imparted to the first fluid conduit 12 is relatively lower than prior art devices.

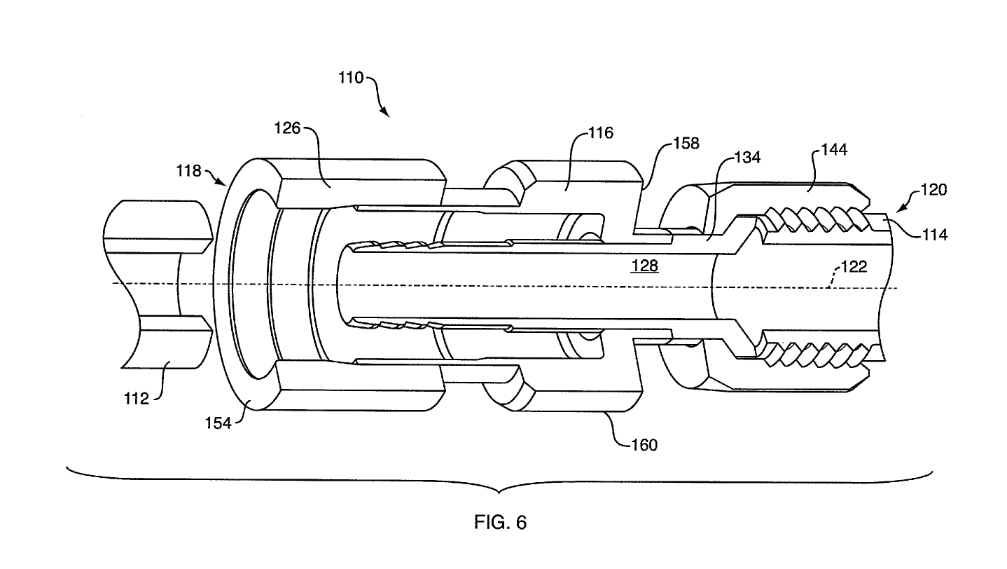

In the example embodiments disclosed above, the coupling body 16 is illustrated as a one-piece, integral design. The inventor has determined that in some applications, it may be advantageous to design some of the features as separate and discrete elements. For example, referring to FIG. 6 wherein like numerals indicate like elements from FIG. 1, a perspective sectional view of a fluid fitting 110 is shown for use in joining the first fluid conduit 112 to a second fluid conduit 114. In the disclosed example, the first fluid conduit 112 is a flexible hydraulic hose, and the second fluid conduit 114 is a male JIC fitting. The fluid fitting 110 includes a coupling body 116 having a first end 118 and a second end 120 defining a longitudinal axis 122. The fitting 110 further includes a separate and discrete nipple 134 disposed in press-fit relation to the body 116, the nipple 134 defining an enclosed passage 128 for flowing a fluid from the first fluid 112 conduit to the second fluid conduit 114, for example. The fitting 110 further includes a separate and discrete coupling element 144 coupled to the nipple 134 to engage the second fluid conduit 114. In the disclosed example, the coupling element 144 is a female JIC swivel nut. A die ring 126 is slideably disposed along the first end 118 of the coupling body 116 to seal the first fluid conduit 112 to the coupling body 116, as discussed above in relation to FIG. 1.

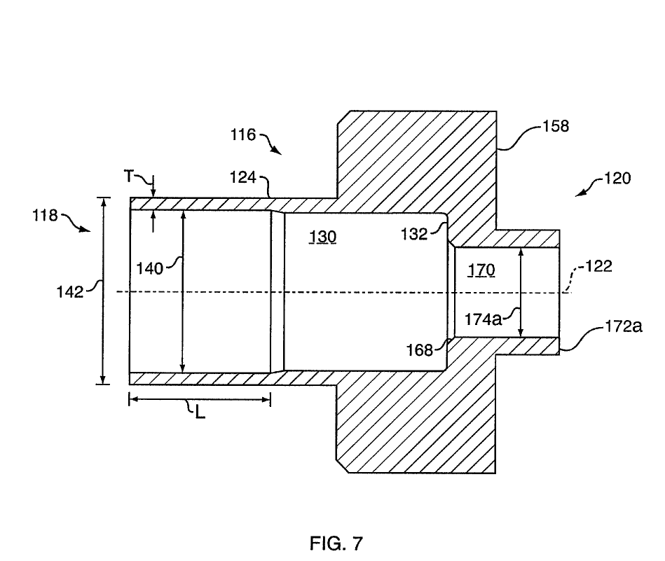

Referring now to FIG. 7 of the drawings, the coupling body 116 is shown in cross-sectional view. The first end 118 of the body defines a first cylindrical cavity 130 centered about the axis 122 for receiving the first fluid conduit 112. A surface 132 of shoulder 168 defined by the coupling body 116 provides a positive stop during insertion of the first fluid conduit 112 and assures the conduit is inserted to a proper depth. The second end 120 of the body 116 defines a central opening 170 in which the nipple 134 is press fit.

The first end 118 of the coupling body 116 further defines a cylindrical compression sleeve 124. As described earlier, the compression sleeve 124 is formed from a thin-walled, deformable material such as brass. An inner diameter 140 of the compression sleeve 124 is sized, in an un-deformed state, to be larger than the outer diameter of the first fluid conduit 112. Together, the inner diameter 140 and an outer diametrical surface 142 of the compression sleeve 124 define a thickness T over a length L. In order to assure adequate deformation of the sleeve 124 during the assembly process, the length L is greater than the thickness T. In one example, the length L is about an order of magnitude greater than the thickness T. In a preferred embodiment, the length L has a length along the axis at least five times greater than the thickness. Although in one example the compression sleeve 124 is made of brass, other ductile materials that are malleable would work well in the context of the invention. For example, the compression sleeve 124 may be made of plastic or polycarbonate material.

The coupling body 116 further includes a second tooling surface 158 for engaging an assembly tool. In the disclosed embodiment, the tooling surface 158 is normal (e.g., perpendicular) to the axis 122. The operation of one example assembly sequence will be explained in detail below.

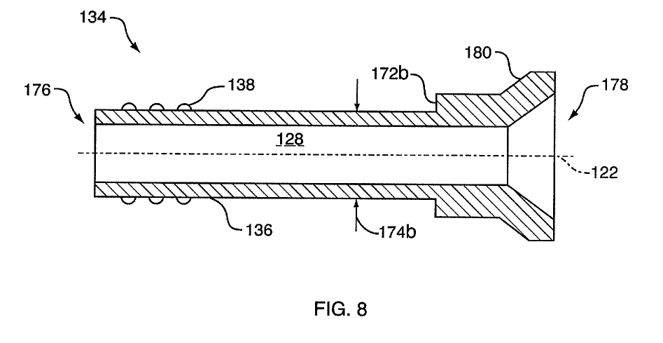

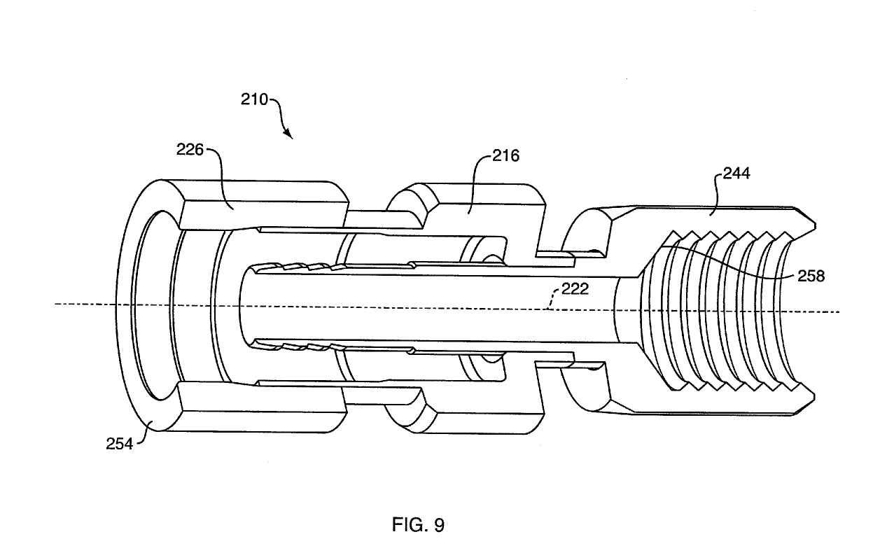

The second end 120 of the coupling body 116 further defines a locating surface 172a for the nipple 134. In the example shown in FIG. 6, the nipple 134 is in press-fit relationship to the coupling body 116. A typical press-fit operation would involving sizing a locating diameter 174a of the central opening 170 a few thousandths of an inch (e.g., 0.001-0.003 inches) smaller than the mating outer diameter of the nipple 134. The coupling body 116 may be positioned on a work bench with the second end 120 oriented vertically. The nipple 134 may be placed over the central opening 170 and pressed into position using an arbor press. A shoulder 172b (FIG. 8) on the nipple 134 engages the locating surface 172a to provide a positive stop.

As used herein, press-fit relationship means any method of securing the nipple 134 such that it will not disengage under normal operating conditions, including but not limited to thermal expansion and contraction, shock loads, and vibration. The nipple 134 could be brazed, welded, or threaded in place without departing from the scope of the invention.

Referring to FIG. 8 of the drawings, the nipple 134 is shown in cross-sectional view. The nipple 134 is generally tubular in shape, having a first end 176 and a second end 178 disposed along the axis 122. The first end 176 of the nipple 134 is configured to accept and provide support for the first fluid conduit 112. The conduit 112 slides over the nipple 134 so that the fluid flow may pass through the enclosed passage 128. To aid in sealing the connection between the conduit 112 and nipple 134 by preventing relative movement, the nipple 134 may include one or more protrusions 138 disposed on an outer diametrical surface 136 of the nipple 134. The protrusions 138 may include bumps, ribs, serrations, or barbs, for example. The protrusions 138 are particularly effective when the first fluid conduit 112 comprises a soft, flexible material such as rubber and the nipple 134 comprises a rigid material such as brass or polyethylene. The protrusions 138 resist the forces developed by thermal expansion and contraction, shock loads, and vibration.

The second end 178 of the nipple 134 defines a locating surface 174b to position the nipple 134 relative to the coupling body 116 during press-fit assembly, as described above. In the disclosed example, surfaces 172a, 172b are perpendicular to the axis 122, but other orientations are possible. At least a portion of the outer diametrical surface 136 includes a complimentary locating diameter 174b. Locating diameter 174b is several thousandths of an inch (e.g., 0.001-0.003 inches) greater than the mating outer diameter of the coupling body 116.

The second end 178 of the nipple 134 further defines an adapter end 180 to engage the coupling element 144. The configuration of the adapter end 180 will depend upon the particular coupling element 144 selected. Referring to FIGS. 5 and 7, the adapter end 180 on the nipple 134 is configured to engage a female JIC swivel nut.

The first fluid conduit 112 may be assembled to the second fluid conduit 114 as follows. In one example, the second fluid conduit 114 may be a male JIC thread to which a hydraulic hose is connected. The coupling element 144, as shown in FIG. 6, is a female swivel head nut, which would be assembled to the male thread. Referring back to FIG. 6, the fluid fitting 110 may be grasped in mid-section 160, which may have wrenching flats, and held firmly while the female nut of the coupling element 144 is installed on the male thread of the second fluid conduit 114. With the second end 114 of the fluid fitting 110 in place, the first end 112 of the coupling body 116 may be installed next.

The assembly of the hydraulic hose is essentially as described with reference to FIG. 1. That is, the hose (first fluid conduit 112) may be inserted through the die ring 126 and into the cylindrical cavity 130 of the coupling body 116 until the hose abuts the surface 132 of shoulder 168. The protrusions 138 prevent the hose from backing out. The assembly tool grasps the first and second tooling surfaces 154 and 158, respectively, and squeezes them towards each other. As the tool imparts an axial force (in a direction parallel to axis 122) to the surfaces 154 and 158, the die ring 126 is urged axially along axis 122 and causes the die ring engagement surface 48 (FIG. 3) to slide along the outer diametrical surface 142 and compress the compression sleeve 124 radially inward. The compression sleeve 124 undergoes uniform radial deformation as the die ring 126 is further urged along the axis 122. The uniform radial deformation pushes the compression sleeve 124 against the first fluid conduit 112 and effects a uniformly tight seal around the outer diameter of the first fluid conduit 112, and physically retains the first fluid conduit 112 from movement.

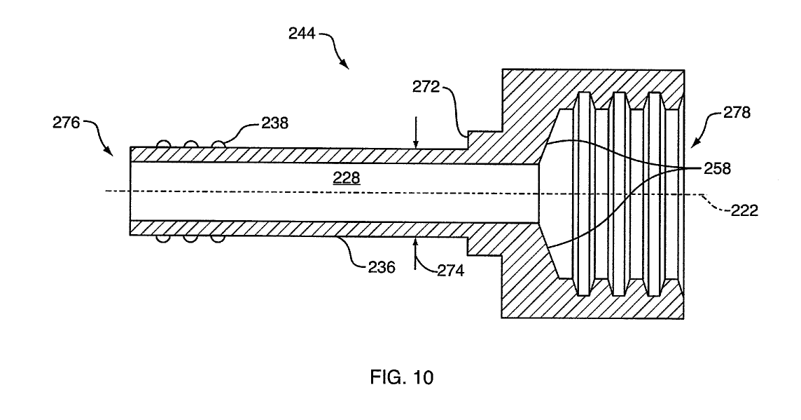

Turning now to FIGS. 8 and 9, wherein like numerals indicate like elements from FIG. 1 and 2, a third embodiment of the fluid fitting 210 includes a coupling body 216, a die ring 226, and a coupling element 244. The coupling body 216 is essentially the same construction as the body illustrated in FIG. 7, and the die ring 226 is essentially the same construction as the body illustrated in FIG. 3. In this embodiment however, the features of the nipple and coupling element are integrated into a single piece to reduce complexity and lower unit costs. The fluid fitting 210 shown may be utilized when the second fluid conduit (not shown) is a male NPT pipe thread, for example.

The coupling element 244 includes a first end 276 and a second end 278 disposed along the axis 222. Similar to the previously described nipple, the coupling element 244 defines an enclosed passage 228 for flowing a fluid from the first fluid conduit to the second fluid conduit. The first end 276 is generally tubular in shape having an outer diametrical surface 236 adapted to accept and provide support to the first fluid conduit. The outer diametrical surface 236 may further include one or more protrusions 238 to secure the first fluid conduit against the forces developed by thermal expansion and contraction, shock loads, and vibration.

The coupling element 244 further defines a locating diameter 274 along at least a portion of the outer diametrical surface 236, adapted to engage a complimentary locating diameter on the coupling body 216. In the embodiment shown, the coupling element 244 is press fit into the coupling body 216, but alternate methods of rigidly securing the two pieces are contemplated. For example, the coupling element 244 could be adapted to thread onto the coupling body 216. In this manner, a first fluid conduit such as a hydraulic hose may be easily fitted to an alternative second fluid conduit simply by changing the coupling element 244.

One example method of assembling the fluid fitting 210 includes an arrangement wherein the first fluid conduit is a hydraulic hose and the coupling element 244 is a swiveling JIC coupling nut. The hose may first be assembled to the fluid fitting 210 as previously disclosed. In this example, the assembly tool is adapted with a plunger tip to push against an inner mandrel face 258 of the nut. The compression tool squeezes against surfaces 254 and 258 to urge the die ring 226 into position. After the fluid fitting 210 is secured to the hose, the swivel nut (coupling element 244) is secured to the hydraulic machinery (second fluid fitting).

Another example arrangement of the fluid fitting 210 may be used when the first fluid conduit is part of a household plumbing system or radiant heating system utilizing cross-linked polyethylene tubing, or PEX. In that example, the second fluid conduit may be a distribution block comprising a series of nipples having male threads. The coupling element 244 may include a female nut as shown, which would be assembled to the distribution block. Then the flexible PEX tubing may be assembled to the fluid fitting 210 in the manner previously described.

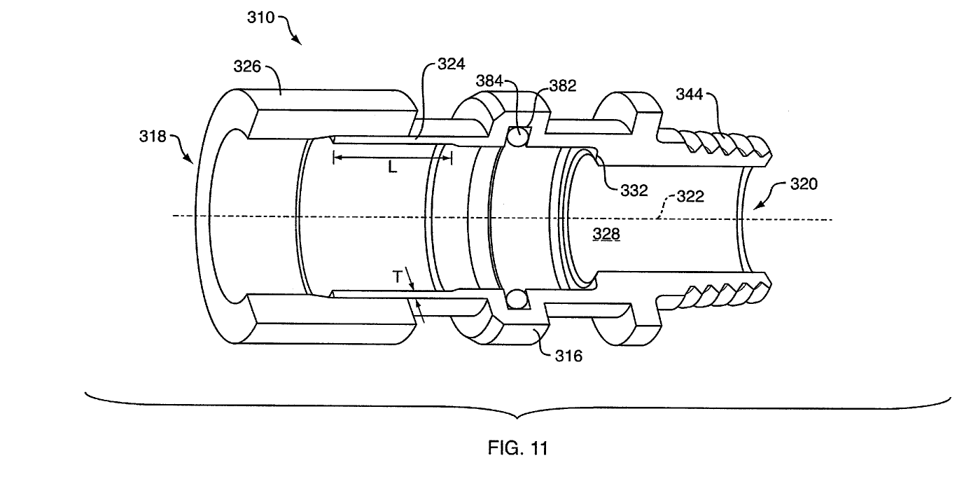

The present inventive fluid fitting may also be adapted to join rigid tubing, such as copper tubing or polyvinyl chloride (PVC). In this particular application, the nipple feature is not necessary since the first fluid conduit does not require internal support. However, a more robust sealing scheme may be required. Referring to FIG. 11, wherein like numerals indicate like elements from FIG. 1, a fourth embodiment of the fluid fitting 310 includes a die ring 326 and a one-piece coupling body 316 having a first end 318 and a second end 320 defining the axis 322. The coupling body 316 defines an internal enclosed passageway 328 for flowing a fluid from the first fluid conduit (not shown) to the second fluid conduit (not shown). A surface 332 provides a positive stop for the rigid first fluid conduit when installed into the coupling body 316. The second end 320 of the coupling body 316 defines a coupling element 344 including the various features described with respect to the embodiment illustrated in FIG. 1.

The coupling body 316 further includes a compression sleeve 324 essentially as described in the previous embodiments, however, the thickness T may be greater to assure a robust seal is established when the die ring 326 deforms the compression sleeve 324 into the rigid first fluid conduit. Due to the rigid nature of the first fluid conduit, deflection or “flaring” may occur at the end of the conduit nearest the surface 332 when the compression sleeve 324 bears down on the conduit. A groove 382 disposed in the coupling body 316 within the enclosed passage 328 is adapted to retain a seal 384 against the first fluid conduit to provide an extra measure of sealing capability. In one example, the seal 384 is a standard o-ring. The rigid first fluid conduit assembles to the fluid fitting 310 in much the same manner as disclosed in the previous embodiments.

The assembly methods and arrangements in each of the disclosed embodiments are intended to provide a more uniform seal contact area than conventional methods of crimping a ring in six or twelve discrete locations on a flexible hose. The segmented crimping die used in such prior art applications leaves irregular contact between the crimp ring and the hose or pipe. As such, the irregular pattern of crimping force may overstress the fitting in some locations along the circumference, while under-stressing other locations. In contrast, the radial pressure applied by the die ring to the compression sleeve of the present invention is uniformly spread over a relatively larger surface area, allowing better control of the stresses required to deform the compression sleeve. This should allow designers to achieve a more robust seal around the periphery of the hose or pipe.

The present invention allows virtually any type of fitting to be mated to a hydraulic hose using hand tools, rather than large, non-transportable hydraulic presses and the like. For example, one prior art method of manufacturing hydraulic hose entails a first step of selecting the proper mating fitting from a catalog. The particular combination of hose and fitting is then ordered, and the manufacturer assembles the fitting to the hose at their factory using a large hydraulic press. The user then waits for delivery. Using the inventive method and apparatus disclosed herein, a simple hand tool will generate sufficient pressure to secure the hose to the fitting. Therefore, hoses may be custom manufactured at the site where they are needed, for example in an emergency, without having to wait for a custom hose to be ordered and shipped. This reduces down time and saves costs.

Another potential advantage to the disclosed fluid fitting 10 is that, in the case of a rigid fluid conduit, the conduit may not be permanently deformed by the assembly process. The compression sleeve 24 may be designed such that its deformation is substantially elastic in nature. Because the die ring 26 is not removed from fluid fitting 10, the compression sleeve 24 does not have to be crushed, or plastically deformed, to effect a proper seal. Therefore, the die ring 26 may removed, and the compression sleeve 24 may spring back enough to allow a rigid first fluid conduit 12 to be removed and re-used.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

I claim:

1. A fitting for securing a first fluid conduit to a second fluid conduit, the fitting comprising:
a coupling body comprising a first end and a second end defining an enclosed passage along a longitudinal axis therethrough, the first end of the coupling body having a deformable compression sleeve, the compression sleeve having an outer diameter and an inner diameter defining a thickness; and
a die ring disposed in surrounding relation to the compression sleeve, the die ring having a central bore extending therethrough, the central bore including an inner surface and an engagement surface, the engagement surface including a diameter that is less than the outer diameter of the compression sleeve, the engagement surface adapted to compress the compression sleeve radially inward when the die ring is urged in an axial direction towards the second end of the coupling body such that a length of the compression sleeve deforms between the inner surface of the die ring and an outer surface of the first fluid conduit.

2. The fluid fitting of claim 1 wherein at least one of the die ring and the compression sleeve includes a taper angle relative to the axis.

3. The fluid fitting of claim 2 wherein the taper angle is in the range of about 1 degree to about 45 degrees.

4. The fluid fitting of claim 3 wherein the taper angle is between 1 degree and 20 degrees.

5. The fluid fitting of claim 1 wherein the engagement surface is a chamfer.

6. The fluid fitting of claim 1 wherein the engagement surface is a radius.

7. The fluid fitting of claim 1 further including a seal disposed within the enclosed passage for sealing against the first fluid conduit.

8. The fluid fitting of claim 7 further including a groove disposed in the coupling body, the groove adapted to retain the seal.

9. The fluid fitting of claim 1 wherein the coupling body further comprises a surface adapted to receive an assembly tool.

10. The fluid fitting of claim 1 wherein the die ring is stiffer than the compression sleeve.

11. The fluid fitting of claim 10 wherein a modulus of elasticity of the die ring is greater than a modulus of elasticity of the compression sleeve.

12. The fluid fitting of claim 1 wherein the compression sleeve has a length along the axis at least five times greater than the thickness.

13. The fitting of claim 1 further including a coupling element adapted to engage the second fluid conduit.

14. The fitting of claim 1 wherein the first end of the coupling body defines a cylindrical cavity, and the fluid fitting further includes a tubular-shaped nipple disposed in the cavity to support the first fluid fitting, the nipple defining the enclosed passage for allowing a fluid to pass from the first fluid conduit to the second fluid conduit.

15. The fitting of claim 14 wherein the nipple includes at least one protrusion to assist in securing the first fluid conduit from movement.

16. The fitting of claim 1 wherein the inner bore of the die ring further includes a pilot diameter adapted for interference fit with the outer diameter of the compression sleeve.

17. The fitting of claim 16 wherein the pilot diameter of the die ring is engaged with the outer diameter of the compression sleeve prior to the first fluid conduit being inserted into the coupling body.

18. A fitting for securing a first fluid conduit to second fluid conduit, the fitting comprising:
a coupling body comprising a first end and a second end defining a longitudinal axis, the first end of the coupling body having a deformable compression sleeve, the compression sleeve having an outer diameter and an inner diameter defining a thickness;
a die ring disposed in surrounding relation to the compression sleeve, the die ring having a central bore extending therethrough, at least a portion of the central bore having an engagement surface, the engagement surface including a diameter that is less than the outer diameter of the compression sleeve, the engagement surface adapted to compress the compression sleeve radially inward when the die ring is urged in an axial direction towards the second end of the coupling body;
a tubular-shaped nipple centered about the axis in press fit relationship with the coupling body, the tubular shape defining an enclosed passage for passing a fluid from the first fluid conduit to the second fluid conduit; a first end of the nipple having at least one protrusion to secure the first fluid conduit, and a second end of the nipple having an adapter; and
a coupling element centered about the axis and having a first end and a second end, the first end of the coupling element configured to engage the adapter, the second end of the coupling element configured to engage the second fluid conduit.

19. The fluid fitting of claim 18 wherein the first fluid conduit is flexible.

20. The fluid fitting of claim 19 wherein the first fluid conduit is hydraulic hose.

21. The fluid fitting of claim 19 wherein the first fluid conduit is cross-linked polyethylene.

22. The fluid fitting of claim 18 wherein the first fluid conduit is rigid.

23. The fluid fitting of claim 18 wherein the coupling body further includes a groove adapted to retain a seal.

24. The fluid fitting of claim 18 wherein the engagement surface is further adapted to deform a length of the compression sleeve between the inner surface of the die ring and an outer surface of the first fluid conduit.

25. A method for securing a first fluid conduit to a fluid fitting, the method comprising the steps of:
providing a coupling body, the coupling body having a first end and a second end defining an enclosed passage along a longitudinal axis therethrough, and a cavity adapted to accept the first fluid conduit, the first end of the coupling body including a deformable compression sleeve having an outer diameter and an inner diameter defining a thickness;
providing a die ring, the die ring having an inner bore defining an inner surface and an engagement surface, the engagement surface including a diameter that is less than the outer diameter of the compression sleeve;
inserting the first fluid conduit into the cavity of the coupling body;
applying a force to the die ring in a direction towards the second end of the coupling body;
sliding the die ring in a direction along the axis to engage the compression sleeve; and
deforming the compression sleeve radially inwards against the first fluid conduit such that at least a portion of the compression sleeve deforms between the inner surface of the die ring and an outer surface of the first fluid conduit.

26. The method of claim 25 wherein the force is applied by a tool.

27. The method of claim 26 wherein the tool engages against a first tooling surface on the die ring and a second tooling surface on the coupling body.

28. The method of claim 27 wherein the first tooling surface and the second tooling surface are perpendicular to the axis.

29. The method of claim 25 wherein coupling body further includes a nipple, and the step of inserting the first fluid conduit into the cavity of the coupling body includes inserting the conduit over the nipple.

30. The method of claim 25 further comprising the step of providing a coupling element on the second end of the coupling body, and engaging a second fluid conduit to the coupling element.
